(19) United States
(12) Patent Application Publication
(10) Pub. No.: US 2008/0017735 A1
(43) Pub. Date: Jan. 24, 2008

(54) A Multifunction Shower Head

(76) Inventor: Huasong ZHOU, Xiamen (CN)

Correspondence Address: Dr. BANGER SHIA, 102 Lindencrest Ct, Sugar Land, TX, 77479-5201, US

(21) Appl. No.: 11/428,721

(22) Filed: Jul. 5, 2006

(51) Int. Cl. A62C 31/00

(52) U.S. Cl. 239/437; 239/380

(57) ABSTRACT

The present invention provides a shifting device of multifunction shower head combined into the cavity of the shower head typically comprised of a shifting button, a radius bar, a swing arm, a coupled gear and division gear; wherein one end of said radius bar is extended out the shower head via a through-hole to fix with a shifting button, the another end has a pilot pin; said swing arm is fixed on the shaft of the coupled gear with one end, the other side is possessed of a slot guide for connecting with said pilot pin of said radius bar; said gearing coupled and division gears are located on the cavity of the shower head via their shaft respectively; said division gear closing on the outlet of the main body has several dividing holes coordinating to the outlet of the main body, to rotate said division gear relative to the outlet of main body can carry out shifting spraying state. The device makes the shifting operation easy and save labor.

### BACKGROUND OF THE INVENTION

1. Field of the Invention

The present invention relates to a multifunction shower head, and more particularly to a shifting device of multifunction shower head.

2. Description of Prior Art

In accordance with the conventional technology, most of the multifunction shower heads are carried out changing the sprayed water state by turning the shifting collar to bring the water divider to rotate relative to the main body. Wherein, said shifting collar is set upon between the spray panel and the main body, so that the diameter of the shifting collar coordinates to the spray panel.

Above-mentioned structure is applied on a small diameter shower head, to turn the small diameter shifting collar is convenient to operation without exerting extra force for shifting the spraying state, but to the bigger diameter shower heads (over the 6 inches) or irregular shower heads, said shifting collar has to be design to appears into bigger diameter so that the hand is difficult to hold, especially to the user with small hand, the turning operation is to hard to carry out. Therefore, it is aimed at by the present invention.

### OBJECTS AND SUMMARY OF THE INVENTION

It is therefore a main object of the present invention to provide a shifting device for multifunction shower head facilitating to easy shifting operation.

For achieving the above-mentioned object, the present invention provides a shifting device combined into the cavity of shower head typically comprised of a shifting button, a radius bar, a swing arm, a coupled gear and division gear; wherein one end of said radius bar is extended out the shower head via a through-hole to fix with a shifting button, the another end has a pilot pin; said swing arm is fixed on the shaft of the coupled gear with one end, the other side is possessed of a slot guide for connecting with said pilot pin of said radius bar; said gearing coupled and division gears are located on the cavity of the shower head via their shaft respectively; said division gear closing on the outlet of the main body has several dividing holes coordinating to the outlet of the main body, to rotate said division gear relative to the outlet of main body can carry out shifting spraying state.

Said division gear is pushed to touch against the outlet of the main body by setting upon a pressure spring on the shaft with fixing one end on the inside wall of the shower head and another on the division gear.

Said through-hole of the shower head is dilled on the spray panel.

Said through-hole of the shower head is dilled on the back side of the main body.

As utilizing above-mentioned structure, in practice, turn the shifting button with fingers to bring the radius bar to rotating, by means of the connection of the pivot pin and the slot guide, to sway the swing arm, further to bring the coupled gear to spinning, via the gearing of the both gears, the division gear is turned relative to the outlet of the main body so that the different dividing holes aim to the outlet of main body to carry out shifting spray state.

Due to the side driving to the division gear by turning the shifting button via said radius bar, said swing arm and said coupled gear, the volume of the shifting button is not affected by the shape and size of the shower head, so the present invention can be applied on any shaped and any sized shower head to carry out shifting spray state function easily and conveniently without any extra force exerting on like the prior art.

### BRIEF DESCRIPTION OF THE DRAWINGS

FIG. 1 is an exploded view of the present invention.

FIG. 2 is a perspective sectional view showing the combination state of the present invention.

FIG. 3 is a top side view showing the combination state of the present invention.

FIG. 4 is a top side view showing the rotating action of the present invention.

FIG. 5 is a cross-section view showing the combination state of the present invention.

### DETAILED DESCRIPTION OF PREFERRED EMBODIMENTS

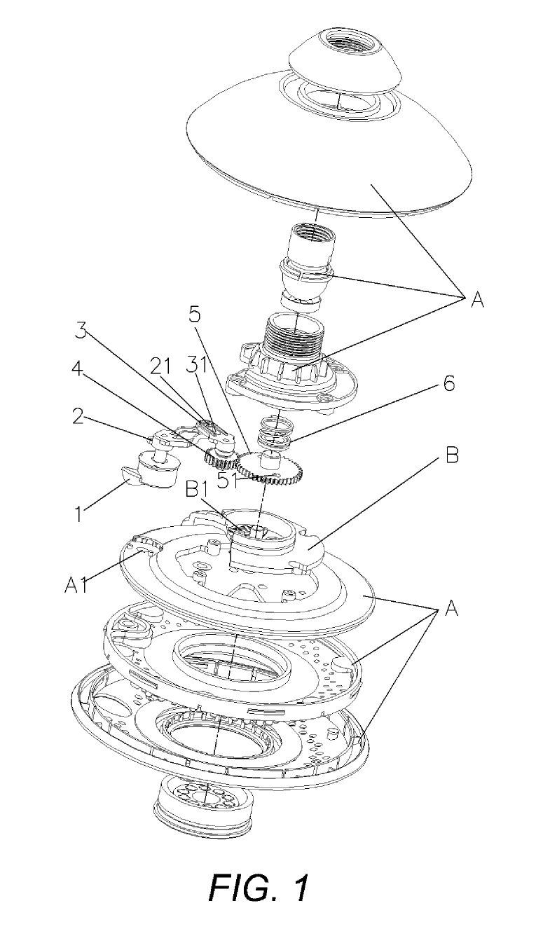

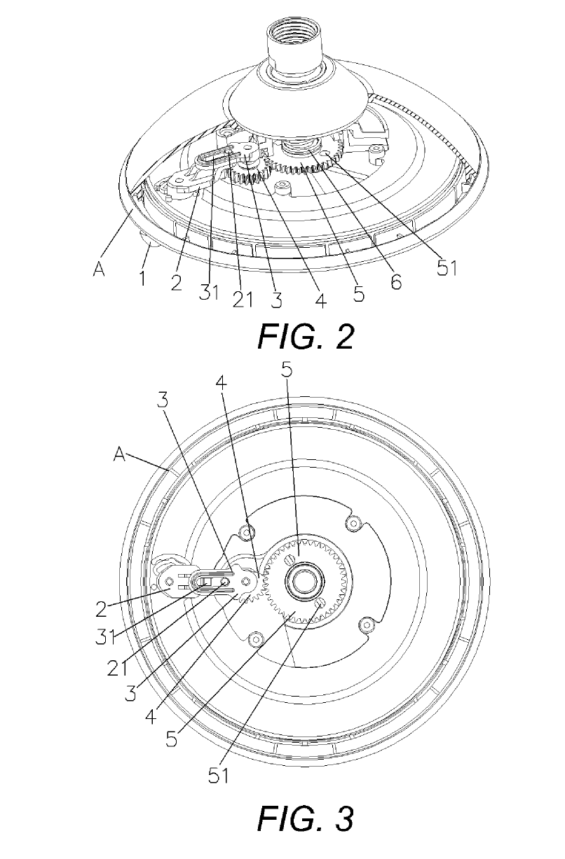

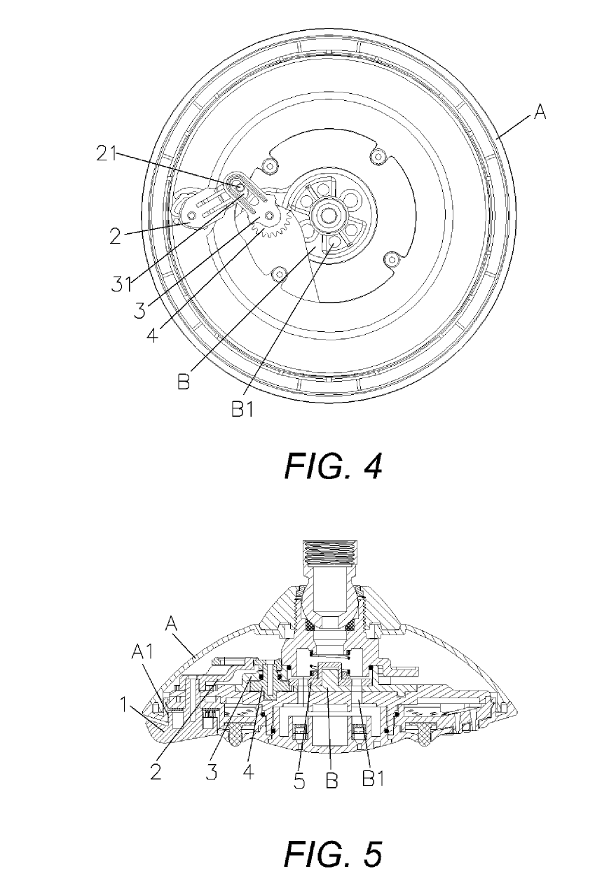

Referring to FIG. 1 and FIG. 2, a shifting device of multifunction shower head discovered by the present invention is typically comprised of a shifting button 1, a radius bar 2, a swing arm 3, a coupled gear 4 and division gear 5.

Wherein, one end of said radius bar 2 is extended out the shower head A via a through-hole A1 to fix on the shifting button 1, another end has a pilot pin 21. Said through-hole A1 of the shower head A can be drilled on the spray panel (as shown in FIG. 3) or on the back side of the main body (not shown in drawings).

Said swing arm 3 is fixed on the shaft of the coupled gear 4 with one end, the other side is possessed of a slot guide 31 for connecting with said pilot pin 21 of said radius bar 2, by means of the connection of the pivot pin and the slot guide, the swing arm 3 can be linked with said radius bar 2 in gang action.

Said gearing coupled 4 and division gears 5 are located on the cavity of the shower head A via their shaft respectively.

For closing to enough tight meanwhile rotating freely, said division gear 5 is pushed to touch against the outlet B of the main body by setting upon a pressure spring 6 on the shaft with fixing one end on the inside wall of the shower head A and another on the division gear 5, said pressure spring 6 not only pushes the division gear 5 to touch against the outlet B of main body tightly, but also assists the division gear 5 rotation in shifting operation.

Due to the side driving to the division gear 5 by turning the shifting button via said radius bar 2, said swing arm 3 and said coupled gear 4, the volume of the shifting button 1 is not affected by the shape and size of the shower head A, so the present invention can be applied on any shaped and any sized shower heads to carry out shifting spray state function easily and conveniently without any extra force exerting on like the prior art.

I claim:

1. A shifting device of multifunction shower head combined into the cavity of shower head typically comprised of a shifting button, a radius bar, a swing arm, a coupled gear and division gear; wherein one end of said radius bar is extended out the shower head via a through-hole to fix with a shifting button, the another end has a pilot pin; said swing arm is fixed on the shaft of the coupled gear with one end, the other side is possessed of a slot guide for connecting with said pilot pin of said radius bar; said gearing coupled and division gears are located on the cavity of the shower head via their shaft respectively; said division gear closing on the outlet of the main body has several dividing holes coordinating to the outlet of the main body, to rotate said division gear relative to the outlet of main body can carry out shifting spraying state.

2. A shifting device of multifunction shower head as claimed in claim 1, wherein said division gear is pushed to touch against the outlet of the main body by setting upon a pressure spring on the shaft with fixing one end on the inside wall of the shower head and another on the division gear.

3. A shifting device of multifunction shower head as claimed in claim 1, wherein said through-hole of the shower head is dilled on the spray panel.

4. A shifting device of multifunction shower head as claimed in claim 1, wherein said through-hole of the shower head is dilled on the back side of the main body.
